(19) United States
(12) Patent Application Publication
(10) Pub. No.: US 2006/0114472 A1
(43) Pub. Date: Jun. 1, 2006

(54) Fizeau interferometer designs for optical coherence tomography

(75) Inventors: Ralph Peter Tatam, Little Harrowden, Northamptonshire (GB); Stephen Wayne James, Cliftonville, Northampton (GB)

Correspondence Address: CARSTENS & CAHOON, LLP, P O BOX 802334, DALLAS, TX, 75380, US

(73) Assignee: CRANFIELD UNVERSITY, Bedfordshire (GB)

(21) Appl. No.: 10/513,366

(22) PCT Filed: May 2, 2003
(86) PCT No.: PCT/GB03/01871

§ 371 Date: Jan. 23, 2006

(51) Int. Cl. G01B 9/02

(52) U.S. Cl. 356/479

(57) ABSTRACT

A number of new interferometer designs for optical coherence tomography applications are described. The interferometers are designed to be light efficient to overcome the poor signal to noise ratio inherent to optical coherence tomography systems.

This invention relates to optical interferometers designed to increase light efficiency to improve the signal to noise ratio (SNR) performance of optical coherence tomography (OCT) instrumentation.

OCT is a high resolution imaging technique that uses low coherence interferometry to provide information from below the surface of semi-transparent materials and is thus able to create three-dimensional images of the material structure. The technique has been employed to investigate composite materials¹ and in particular biological tissue². Interference signals are detected when light backscattered from different refractive index interfaces within the media e.g. tissue layers, is combined with a reference beam.

The SNR of an OCT system is proportional to the optical source power and inversely proportional to the detector bandwidth A high SNR is important in OCT imaging as very low light intensities are reflected back from biological tissue samples and these need to be detected. As real-time OCT imaging is generally essential for clinical applications³⁻⁶ most OCT systems require detectors with bandwidths of the order of MHz and so optimisation of the SNR is advantageous to achieve high quality images and it is desirable therefore to minimise the loss of optical power within the OCT system.

OCT is a suitable technique for in vivo, endoscopic applications⁷⁻⁸ allowing high-resolution, depth images to be produced effectively without any harmful, adverse effects to patients as it uses low power, incoherent light as its imaging source.

The fibre optic Michelson Interferometer configuration² is one embodiment of an OCT instrument, and has been the most common OCT system. The fibre optic Michelson interferometer has proved to be successful for in vitro imaging, although it may not be the best configuration for endoscopic applications. Environmental changes in the sample arm may induce polarisation and phase changes that could dramatically decrease the visibility of the signal.

A second embodiment is the Fizeau interferometer⁹, the configuration of which eliminates polarisation and phase changes in the system due to environmental changes, by allowing light in the sample and reference arms to travel down the same optical fibres. A sensing interferometer is formed between the distal end of the fibre and the tissue sample. Perturbations of the interference signal due to bending of the fibre and temperature changes, which may induce phase and polarisation changes, do not affect the interference pattern observed at the detector. Another advantage of the Fizeau arrangement is that the directional coupler and the processing interferometer can be housed separately from the sensing head when in clinical use.

In the fibre Michelson and Fizeau configurations employing directional couplers, around 75% and 94% respectively of the initial signal power is lost.

It may be possible using alternative optical components that power conserving interferometers can be constructed that have such properties that a Fizeau interferometer configuration can achieve a higher SNR than that of a conventional Michelson arrangement and a comparable SNR to a Michelson optimised for power conservation.

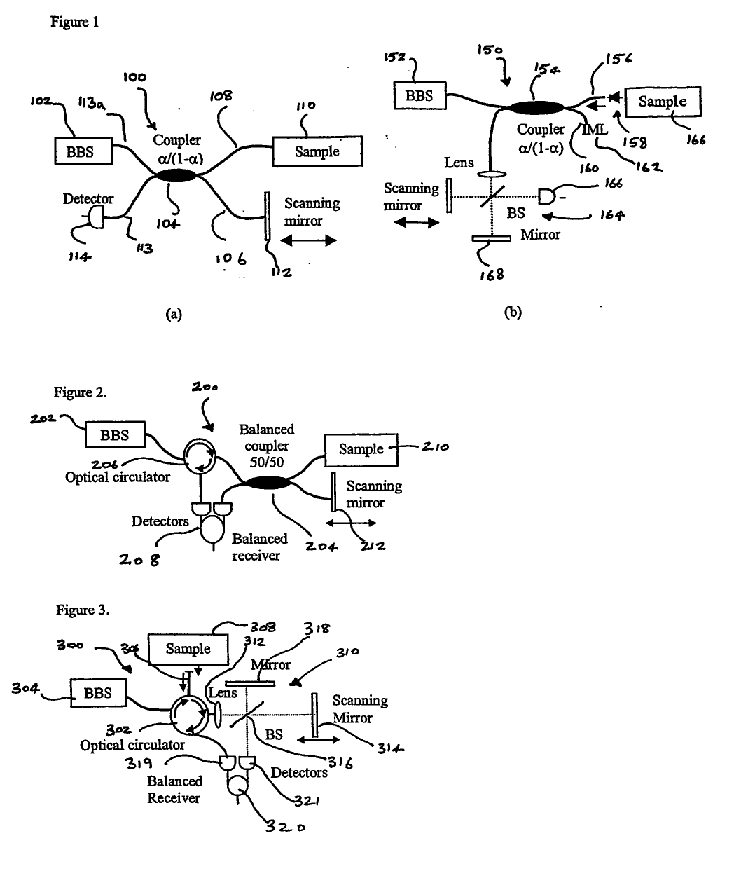

The Michelson configuration (100) is shown in FIG. 1a. Light from a low coherence source (102) is split by a 3 dB coupler (104) into a reference arm (106) and a sample arm (108). Light in the sample arm (108) is reflected back from many reflecting sites within the tissue sample (110). An axially scanning reference mirror (112) reflects light in the reference arm (106) and both beams recombine at the coupler (104). When the path length between the sample arm (108) and the reference arm (106) is equal, or to within the coherence length of the source (102), interference signals will be detected through the exit arm (113) of the coupler (104). As light from both interferometer arms (106, 108) is split 50/50 by the coupler (104) on return from reflection, 50% of the light returns through the source arm (113a) and is lost resulting in a lower Signal to Noise Ratio (SNR) at the detector (114). The photocurrent with its AC and DC components for the Michelson interferometer is given by:
I_{Tot}=[Pᵣ+Pₛ+Pₓ+2\sqrt{PᵣPₛ} cos(k₀ΔL)] (1)
I_{DC}= [symbol] (Pᵣ+Pₛ+Pₓ) (2)
I_{AC}=2 [symbol] ²PᵣPₛ (3)

Where I_{Tot} is the total photocurrent, ρ is the responsivity of the detector, Pᵣ and Pₛ are the reflected powers from the reference and sample arms which are coherent with the reference beam. k₀ is the wave number of the centre wavelength of the source and ΔL is the path length difference between the sample and reference arm. The light backscattered from the sample is considered negligible compared with the reference power.

The Fibre Fizeau interferometer⁹ (150) is shown in FIG. 1b. Light from a low coherence source (152) is split by a 3 dB directional coupler (154), 50% propagates down a sample arm (156) to the Fizeau sensing head (158) and 50% travels down the other arm (160) with the output immersed in Index Matching Liquid (IML) (162), which prevents reflections back down the fibre. The light travelling down the sample arm (156) enters the Fizeau sensing head (158) where approximately 4% of the light at the end of the fibre is Fresnel reflected back down to the coupler (154). This is then guided to a processing interferometer (164) (in the case of FIG. 1b a Michelson interferometer although any other receiving interferometer may be used). This acts as the reference beam for the interferometer (164). The light that is not Fresnel reflected is focussed onto the tissue and back scattered from the different microstructures within a sample (166) and coupled back into the fibre. The light is then guided to the receiving interferometer (164). Interference fringes are observed at a detector (166) when the path length of the Fresnel reflected light matches that of the tissues reflecting sites to within the coherence length of the source (152). A reference mirror (168) within the processing interferometer (164) is scanned axially so that all the interference signals, corresponding to the reflections in the tissue, are observed at the detector (166). The total photocurrent with its AC and DC components is given by:

$$\begin{matrix}{I}_{Tot} = ϱ [ \begin{matrix}{P}_{r1} + {P}_{r2} + {P}_{s1} + {P}_{s2} + {P}_{x} + 2 ( \sqrt{{P}_{r1} {P}_{s1}} + \sqrt{{P}_{r2} {P}_{s2}} ) \\ cos ( {k}_{0} {L}_{1} ) + 2 ( \sqrt{{P}_{r1} {P}_{r2}} + \sqrt{{P}_{s1} {P}_{s2}} ) cos ( {k}_{0} {L}_{2} ) + \\ 2 \sqrt{{P}_{r1} {P}_{s2}} cos {k}_{0} ( {L}_{1} + {L}_{2} ) + 2 \sqrt{{P}_{r2} {P}_{s1}} cos {k}_{0} ( {L}_{1} - {L}_{2} )\end{matrix} ] & ( 4 ) \\ {I}_{D C} = ϱ [ {P}_{r1} + {P}_{r2} + {P}_{s1} + {P}_{s2} + {P}_{x} ] & ( 5 ) \\ {I}_{A C} = 2 {ϱ}^{2} {P}_{r} {P}_{s} & ( 6 )\end{matrix}$$

Where Pₓ is the power from the sample arm incoherent with the reference light, Pᵣ₁ and Pᵣ₂ are the reflected light from the fibre end travelling down arm 1 and 2 of the receiving Michelson interferometer. Pₛ₁ and Pₛ₂ are the reflected sample light travelling down arm 1 and 2 of the receiving interferometer. The backscattered sample power is again considered negligible.

The SNR for an interferometer is expressed in dB and given by:

$$SNR = 10 log ( \frac{〈 {I}_{A C}^{2} 〉}{{σ}_{tot}^{2}} ) \qquad ( 7 )$$

The total photocurrent variance (σₜₒₜ²) is a summation of the shot noise (σ_{Sh}²), excess noise (σₑₓ²) and receiver noise (σ_{rec}²), and given respectively by:

$$\begin{matrix}{σ}_{Sh}^{2} = 2 {qI}_{d c} B & ( 8 ) \\ {σ}_{ex}^{2} = ( 1 - {V}^{2} ) {I}_{d c}^{2} \frac{B {λ}_{0}^{2}}{c {λ}_{FWHM}^{2}} ( \frac{2 ln 2}{π} ) & ( 9 )\end{matrix}$$

where q is the electronic charge and B is the electronic bandwidth, V is the degree of polarisation, c is the free space speed of light, Δλ_{FWHM} is the full width at half-maximum wavelength of the source and λ₀ is the centre wavelength of the source. Receiver noise (σ_{rec}²) occurs due to thermal noise within the detector and is usually specified by the manufacturer for commercial devices.

If balanced detection is used, excess photon noise can be considered negligible. A component of the excess noise does remain called the beat noise (σ_{be})⁹ and is given by:

$${σ}_{be}^{2} = \frac{( 1 + {V}^{2} ) {ϱ}^{2} {P}_{r} {P}_{x} B {λ}_{0}^{2}}{c {λ}_{FWHM}^{2}} {( \frac{2 ln 2}{π} )}^{\frac{1}{2}} \qquad ( 10 )$$

The total signal photocurrent for both the Michelson and Fizeau configurations in balanced detection is the sum of the photocurrent in both detectors and is given by:
I_{AC}²=8 [symbol] ²PᵣPₛ (11)

The invention will now be described by way of example only, with reference to the accompanying drawings in which:

FIG. 1(a) is a Fibre Michelson Interferometer;

FIG. 1(b) is a Fibre Fizeau interferometer with receiving Michelson interferometer. (BBS=broadband source, α=splitting ratio, BS=beam splitter);

FIG. 2 is a Michelson interferometer configuration with balanced coupler, circulator and balanced detection. BBS=broadband source (Pᵣ=P₀RᵣT_{c}²/4, Pₛ=P₀RₛT_{c}²/4, Pₓ=P₀RₓT_{c}²/4);

FIG. 3 is a Fizeau configuration with a circulator and no coupler, using balanced detection (BBS=broadband source, BS=beamsplitter)
(Pᵣ=P₀T_{c}³Rᵣ/4, Pₛ=P₀T_{c}³Rₛ(1−Rᵣ)²/4, Pₓ=P₀T_{c}³Rₓ(1−Rᵣ)²/4, Pᵣ₁=Pᵣ₂=Pᵣ);

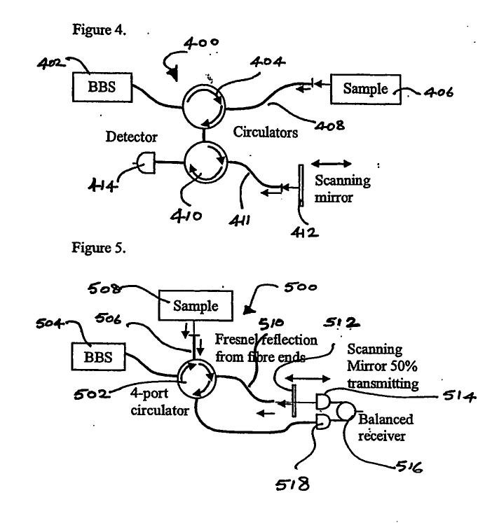

FIG. 4 is a Fizeau sensing interferometer with Fizeau receiving interferometer using 2×3-port circulators BBS=broadband source
(Pᵣ=Pᵣ₁=P₀RᵣT_{c}⁴(1−r)², Pᵣ₂=P₀RᵣT_{c}⁴r², Pₛ=P₀RₛT_{c}⁴(1−Rᵣ)²r, Pₓ=P₀RₓT_{c}⁴(1−Rᵣ)²r); and

FIG. 5 is a Fizeau sensing interferometer with Fizeau receiving interferometer using a 4-port circulator and balanced detection. BBS=broadband source
(Pᵣ=Pᵣ₁=P₀RᵣT_{c}²r(1−r)/4, Pᵣ₂=P₀RᵣT_{c}²(1−r)/2, Pₛ=P₀RₛT_{c}²(1−Rᵣ)²(1−r)/2, Pₓ=P₀RₛT_{c}²(1−Rᵣ)²(1−r)/2)

The parameters used are identical to those used in the previous study¹⁰ to provide a comparison. The SNR is calculated using the following values; Rₛ=1, R_{f}=0.1, Rₓ=0.0005, ρ=0.95 and the receiver noise current=2 pA/Hz^{1/2}. The optical power of the source was assumed to be 20 mW with a 1300 nm-centre wavelength and a 50 nm bandwidth. The source was unpolarised and B=1 MHz. Transmission through the circulator, T_{c}=0.85.

The SNR for three configurations of interferometers were investigated, the Michelson¹⁰, Mach-Zehnder¹⁰ and the Fizeau⁹. This study follows previous work reported by Rollins et al¹⁰ but has been extended to include the Fizeau configurations. Each interferometer was modified using circulators and unbalanced couplers to improve power conservation. A circulator being an optical circulation means in which light input at, for example, terminal 1 is output at terminal 2 and light input at terminal 2 is output at terminal 3 etc. An unbalanced coupler is a coupling means in which the intensity ratio in which light is split down each output channel of the coupler is not 1:1. A circulator has the advantage over a coupler that the majority of the light input at a terminal exits the subsequent terminal, no splitting of the intensity of a beam of light occurs. The SNR for each configuration was calculated using equation 7 and results are shown in Table 1. Where r is the reflectivity of the fibre in the Fizeau receiving interferometer and T_{c} is the transmission through the circulator.

Referring now to FIG. 2, the highest SNR achieved for the Michelson configuration (200) comprising a light source (202) was 104 dB using a balanced coupler (204), circulator (206) and balanced detection¹⁰. The balanced detection comprised a two channel detector (208) arranged to receive at one input channel light that had passed from the coupler (204) to the detector (208) via the circulator (206) from a sample (210) and scanning means, typically a scanning mirror (212), and on the other channel light that passed directly from the coupler (204) to the detector (208) from a sample (210) and a scanning mirror (212). An alternative form of scanning means to a scanning mirror is a diffraction grating that scans by rotating, typically about a centre point thereof.

A balanced coupler is a coupling means in which the ratio in which light is split down each output channel of the coupler is 1:1. A balanced detection arrangement is one in which a detection means, usually a multiple input channel detector, receives inputs from each of a number of signals, typically two signals, originating from the same source and measuring the same parameter. Each of the signals has a different characteristic, for example phase, but, as the signals originate from the same source and measure the same parameter, noise cancellation can be effected by any of a number of known techniques.

FIG. 3 shows a Fizeau configuration (300) using a single circulator (302) and no coupler, balanced detection is used and increases the SNR to 101 dB. Light emitted from a broadband source (304) enters the circulator (302) and is passed via an optical fibre (306) to a sample (308), a fraction of the light is Fresnel reflected from an internal surface of a distal end of the fibre (306) back into the circulator (302) and acts as a reference for an analysing interferometer (310). Light scattered from the sample (308) also passes back up the fibre (306).

The interferometer (310) comprises a lens (312), a scanning mirror (314), a beamsplitter (316) and a fixed mirror (318). Light enters the interferometer (310) from the circulator (302) via the lens (312) and impinges upon the beamsplitter (316) where a fraction is directed to the scanning mirror and a fraction to the fixed mirror (318).

A fraction of the light within the interferometer (310) exits via the lens (312) to the circulator (302) from where the light passes to one input (319) of a balanced detector (320). The other fraction of the light within the interferometer (310) passes directly from the interferometer to another input (321) of the balanced detector (320).

Referring now to FIG. 4, another suitable configuration uses a receiving Fizeau interferometer (400) in which the SNR without balanced detection is 77 dB with 0.4 end of fibre reflectivity and with balanced detection 98 dB. The photocurrent for this configuration is the same for the Fizeau configuration with a receiving Michelson interferometer (equation 1) as there are four beams recombining at the detector.

A broad band source (402) inputs light to a first optical circulator (404) which outputs the light to a sample (406) via an optical fibre (408), as described hereinbefore with reference to FIG. 3 a portion of the light is reflected back to the circulator from an end surface of the fibre (408) and acts as a reference for an analysing interferometer and a light reflected and/or scattered from the sample (406) is also passes back up the fibre (408) to the circulator.

The first optical circulator (404) passes the reflected and scattered light to a second optical circulator (410) from where the light is output along an optical fibre (411) to a scanning mirror (412). A fraction of the light is Fresnel reflected from an internal surface of an end of the optical fibre (411). The scanning mirror (412) moves axially in order to scan through interference fringes. Light reflected from the scanning mirror (412) passes along the optical fibre (411) and into the second optical circulator (410) from where it is passed to a detector (414).

FIG. 5 shows how balanced detection is used for a receiving Fizeau configuration (500) modified to use a single 4-port circulator (502). Light from a broad band source (504) enters the circulator (502) and is passed along a fibre (506) to a sample (508), reflection and scattering occurs as described hereinbefore with reference to FIGS. 3 and 4. Scattered and reflected light enters the circulator (502) via the fibre (506). This light is output from the circulator (502) along a second fibre (510) to a partially transmissive, typically 50% transmissive, scanning mirror (512). Reflection of light occurs at an internal end surface of the second fibre (510) as noted hereinbefore with reference to FIG. 4.

Light passing through the partially transmissive scanning mirror (512) passes to a first input (514) of a balanced receiver detector (516). Light reflected from the partially transmissive scanning mirror (512) passes back along the second optical fibre (510) to the circulator (502) from where it is output to a second input of the balanced receiver detector (516). The SNR for this configuration is 78 dB without balanced detection and 99 dB with balanced detection.

We have calculated the SNR for a number of fibre optic OCT configurations in order to determine designs with the best SNR (Table.1). These designs have been compared to previous designs studied by Rollins et al¹⁰. The new Fizeau designs have shown to give a comparable SNR values to the previous Michelson designs with the added advantage of eliminating unwanted polarisation effects in the fibres that may decrease the SNR. Overall all designs significantly improved the SNR compared to their conventional configurations. Up to 20 dB improvement for the Michelson case and 25 dB for the Fizeau. The use of balanced detection was shown to give the greatest SNR improvement. With the need for faster scanning techniques it is desirable to have a high SNR and these systems have shown that it is achievable.

TABLE 1
Summary of the SNR values calculated for each interferometer
design. RAR = Reference Arm Reflectivity, EofR = End
of fibre reflection, NA = not applicable.

| | | | SPLIT- |
|---|---|---|---|
| INTERFEROMETER | | | TING |
| DESIGNS | MAX SNR | | RATIO |
| MICHELSON | | | |
| CONFIGURATIONS | | | |
| Unbalanced coupler | 84 dB | (84 dB¹⁰) | 0.5 |
| Unbalanced coupler and | 99 dB | (99 dB¹⁰) | 0.1 |
| circulator | | | |
| Unbalanced coupler and | 104 dB | (104 dB¹⁰) | |
| circulator with | | | |
| balanced detection | | | |
| FIZEAU SENSING | | | |
| CONFIGURATIONS | | | |
| Unbalanced coupler and | 77 dB | | 0.5 |
| a receiving Michelson | | | |
| interferometer | | | |
| Circulator only and a | 77 dB | | NA |
| processing Michelson | | | |
| interferometer | | | |
| 2 circulators and a | 100 dB | | NA |
| processing Michelson | | | |
| interferometer using | | | |
| balanced detection | | | |
| Single circulator and | 101 dB | | NA |
| a processing Michelson | | | |
| interferometer using | | | |
| balanced detection | | | |
| Fizeau processing | 77 dB | (Processing | NA |
| interferometer using | | EoFR = 0.4) | |
| 2 × 3-port circulators | | | |
| Fizeau processing | 98 dB | (Processing | NA |
| interferometer using | | EoFR = 0.45) | |
| 2 × 3-port circulators | | | |
| and a 50% transmitting | | | |
| mirror for balanced | | | |
| detection | | | |
| Fizeau processing | 78 dB | (Processing | NA |
| interferometer using | | EoFR = 0.4) | |
| 1 × 4-port circulator | | | |
| Fizeau processing | 99 dB | (Processing | NA |
| interferometer using | | EoFR = 0.45) | |
| 1 × 4-port circulators | | | |
| and a 50% transmitting | | | |
| mirror for balanced | | | |
| detection | | | |

REFERENCES
[1] M. Bashkansky, M. D. Duncan. Opt. Lett. 22, (1997) 61-3.
[2] D. Huang, E. A. Swanson, P. C. Lin. Science. 25 (1991) 1178-1181.
[3] J. Ballif, R. Gianotti, P. H. Chavanne. Opt. Lett. 22 (1997) 757-759.
[4] J. Szydlo, H. Bleuer, R. Walti. Meas. Sci and Tech. 9 (1998) 1159-1162.
[5] G. J. Tearney, B. E. Bouma, J. G. Fujimoto. Opt. Lett. 22 (1997) 1811-1813.
[6] J. G. Fujimoto, C. Pitris, S. A. Boppart. Neoplasia. 2 (2000) 9-25.
[7] B. E. Bouma, G. J. Tearney. Opt. Lett. 24 (1999) 531-533.
[8] S. D. Dyer, D. A. Christensen. Opt. Eng. 36 (1997) 2440-2447.
[9] K. J. Bamford, S. W. James, H. Barr, R. P. Tatam. Lasers Med Sci. 15 (2000) 188-194.
[10] A. M. Rollins, J. A. Izatt. Opt. Lett. 24 (1999) 1484-1486.

What we claim is:

1. Optical coherence tomography apparatus comprising a light source, scanning means, detection means, and optical circulation means, the optical circulation means lying in an optical path between the light source and the detection means, and being arranged to direct light emitted from the light source to both a sample and the scanning means.

2. Apparatus according to claim 1 wherein coupling means is arranged to direct light emitted from the light source, received from the optical circulation means, to both the sample and the scanning means.

3. Apparatus according to claim 2 wherein the coupling means is a balanced coupler.

4. Apparatus according to claim 1 wherein the optical circulation means is arranged to direct at least some light reflected from the scanning means to a first input of the detection means.

5. Apparatus according to any claim 1 wherein the optical circulation means is arranged to direct at least some light reflected or scattered from the sample to an input of the detection means.

6. Apparatus according to claim 1 wherein the optical circulation means is arranged to direct light scattered and/or reflected by the sample to the scanning means.

7. Apparatus according to claim 6 wherein the optical circulation means is arranged to direct light from the scanning means to an input of the detection means.

8. Apparatus according to claim 6 wherein the optical circulation means is arranged to receive Fresnel reflected light from an end of an optical fibre.

9. Apparatus according to claim 8 wherein the optical fibre is arranged to carry light between the optical circulation means and either of the sample or the scanning means.

10. Apparatus according to claim 6 wherein the scanning means comprises a partially transmissive mirror.

11. Apparatus according to claim 10 wherein the partially transmissive mirror is arranged to transmit a fraction of the light incident thereupon to an input of the detection means.

12. Apparatus according to claim 10 wherein the partially transmissive mirror is approximately 50% transmissive and approximately 50% reflective at at least one wavelength of interest.

13. Apparatus according to claim 1 wherein the optical circulation means comprises at least one optical circulator.

14. Apparatus according to claim 13 wherein each of the at least one optical circulator has a transmission of approximately 0.85 or better.

15. Apparatus according to claim 1 wherein the scanning means comprises a mirror.

16. Apparatus according to claim 1 wherein the light source comprises a broad band light source.

17. Apparatus according to claim 1 wherein the detection means comprises a balanced receiver.

18. Apparatus according to claim 1 wherein a signal to noise ratio of approximately any one of the following is achieved: >104 dB, 104 dB, 99 dB, 98 dB, 78 dB, 77 dB.

19. Apparatus according to claim 1 comprising a Fizeau interferometer.

20. Optical coherence tomography apparatus comprising a light source, a scanning mirror, a detector, and an optical circulator, the optical circulator lying in an optical path between the light source and the detector, and being arranged to direct light emitted from the light source to both a sample and the scanning mirror.

21. Apparatus according to claim 20 wherein a balanced coupler is arranged to direct light emitted from the light source, received from the optical circulator, to both the sample and the scanning mirror.

22. Apparatus according to claim 20 wherein the optical circulator is arranged to direct light scattered and/or reflected by the sample to the scanning mirror.

23. Apparatus according to claim 22 wherein the optical circulator is arranged to direct light from the scanning mirror to an input of the detector.

24. Apparatus according to claim 22 or 23 wherein the optical circulation means is arranged to receive Fresnel reflected light from an end of an optical fibre.

25. Apparatus according to claim 24 wherein the optical fibre is arranged to carry light between the optical circulator and either of the sample or the scanning mirror.

26. Apparatus according to claim 22 wherein the scanning mirror comprises a partially transmissive mirror.

27. Apparatus according to claim 26 wherein the partially transmissive mirror is arranged to transmit light to an input of the detector.

28. Apparatus according to claim 22 wherein the detector comprises a balanced receiver.

29. Apparatus according to claim 22 comprising a Fizeau interferometer.
